(19) United States
(12) Patent Application Publication
(10) Pub. No.: US 2008/0188622 A1
(43) Pub. Date: Aug. 7, 2008

(54) PROPYLENE-BASED COPOLYMER MATERIAL, FILM MADE THEREFROM, AND METHOD FOR PRODUCING PROPYLENE-BASED COPOLYMER MATERIAL

(75) Inventor: Hiroshi NOZAWA, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/021,372

(22) Filed: Jan. 29, 2008

(30) Foreign Application Priority Data
Feb. 1, 2007 (JP) 2007-022848

(51) Int. Cl. C08L 23/16

(52) U.S. Cl. 525/240

(57) ABSTRACT

A propylene-based copolymer material is provided which includes 1 to 10% by weight of a propylene-based copolymerized component (1) defined below and 90 to 99% by weight of a propylene-based copolymerized component (2) defined below and which has a melting point not higher than 140° C., wherein the propylene-based copolymerized component (1) is a propylene-based copolymerized component which includes 89 to 97% by weight of propylene units, 0 to 1.5% by weight of ethylene units and 3 to 10% by weight of 1-butene units and which has a melting point within the range of 145° C. to 155° C., and the propylene-based copolymerized component (2) is a propylene-based copolymerized component which includes 80 to 94% by weight of propylene units, 0 to 10% by weight of ethylene units and 0 to 20% by weight of 1-butene units. A film made from the copolymer material is also provided.

### BACKGROUND OF THE INVENTION

1. Field of the Invention

The present invention relates to propylene-based copolymer materials and films made therefrom. In particular, the present invention relates to propylene-based copolymer materials well-balanced in heat sealability and anti-blocking property and films made therefrom.

2. Description of the Related Art

Films made from propylene-based copolymers are widely used in the field of packaging materials such as food packaging materials and fiber packaging materials due to their superior appearance and stiffness.

For example, U.S. Pat. No. 5,948,547 discloses compositions exhibiting both a relatively high melting point and a relatively low sealing temperature containing two random propylene copolymers of different composition. Specifically, it discloses compositions based on propylene polymers (compositions (C)) comprising: from 68 to 80% by weight of a random propylene copolymer (copolymer (A)) which contains from 12 to 20% by weight of units derived from 1-butene and from 0 to 2% by weight of units derived from ethylene, and from 32 to 20% by weight of a random propylene copolymer (copolymer (B)) which contains from 0 to 15% by weight of units derived from 1-butene and from 1 to 8% by weight of units derived from ethylene, the composition of the two copolymers (A) and (B) being different.

U.S. Pat. No. 6,365,682 discloses terpolymers of propylene and at least two α-olefin monomers, the terpolymers being suitable, e.g., for applications where good heat sealability and softness are required. Specifically, it discloses a terpolymer of propylene, comprising comonomer units derived from ethylene and at least one α-olefin selected from the group of C₄-C₈ α-olefins, the ratio of ethylene to the C₄-C₈ α-olefin(s) being less than 0.3 and the hexane-soluble fraction is less than 6.5% calculated from the total weight of the terpolymer.

Generally, in the production of packaging materials such as bags from films made of propylene-based copolymers, heat sealing, which is a technique of adhering films together by thermal welding, is used widely. In the production of packaging materials by heat sealing, the production efficiency of packaging materials can be improved by use of films having low welding temperatures. However, films having low welding temperatures tend to be poor in anti-blocking property and propylene-based copolymers well-balanced in heat sealability and anti-blocking property have not been developed yet.

### SUMMARY OF THE INVENTION

The object of the present invention is to provide propylene-based copolymer materials suitable as materials of films well-balanced in heat sealability and anti-blocking property.

In one aspect, the present invention is directed to a propylene-based copolymer material which comprises from 1 to 10% by weight of a propylene-based copolymerized component (1) defined below and from 90 to 99% by weight of a propylene-based copolymerized component (2) defined below and which has a melting point not higher than 140° C., where the amounts are based on the total weight of the propylene-based copolymerized components (1) and (2),

wherein the propylene-based copolymerized component (1) is a propylene-based copolymerized component which comprises from 89 to 97% by weight of structural units derived from propylene, from 0 to 1.5% by weight of structural units derived from ethylene and from 3 to 10% by weight of structural units derived from 1-butene and which has a melting point within the range from 145° C. to 155° C., where the amounts are based on the weight of the component (1), and
the propylene-based copolymerized component (2) is a propylene-based copolymerized component which comprises from 80 to 94% by weight of structural units derived from propylene, from 0 to 10% by weight of structural units derived from ethylene and from 0 to 20% by weight of structural units derived from 1-butene, where the amounts are based on the weight of the component (2).

In another aspect, the present invention is directed to a film comprising the propylene-based copolymer material.

In still another aspect, the present invention is directed to a method for producing the propylene-based copolymer material, wherein the propylene-based copolymerized component (1) is produced in a medium composed mainly of liquid propylene and the propylene-based copolymerized component (2) is produced in a medium composed mainly of gaseous propylene.

The propylene-based copolymer material of the present invention is suitable as a material of films well-balanced in heat sealability and anti-blocking property. Packaging materials such as bags can be produced at high production efficiency by heat sealing films containing that material.

### DESCRIPTION OF THE PREFERRED EMBODIMENTS OF THE INVENTION

The propylene-based copolymer material of the present invention is a propylene-based copolymer material which comprises from 1 to 10% by weight a propylene-based copolymerized component (1) and from 90 to 99% by weight of a propylene-based copolymerized component (2), both of which are described in detail below, where the amounts indicated above are based on the total weight of the propylene-based copolymerized components (1) and (2).

The propylene-based copolymerized component (1) comprises from 89 to 97% by weight of structural units derived from propylene, from 0 to 1.5% by weight of structural units derived from ethylene and from 3 to 10% by weight of structural units derived from 1-butene, and preferably comprises from 93 to 97% by weight of structural units derived from propylene, from 0 to 1.5% by weight of structural units derived from ethylene and from 3 to 5.5% by weight of structural units derived from 1-butene, where the amounts indicated above are based on the combined weight of all structural units of the component (1), namely the weight of the component (1). From the viewpoint of anti-blocking property, the content of the structural units derived from ethylene of the propylene-based copolymerized component (1) is preferably 0% of the weight.

When the content of the structural units derived from propylene is less than 89% by weight, the anti-blocking property may be insufficient. When the content is over 97% by weight, the heat sealability may be insufficient. When the content of the structural units derived from ethylene is over 1.5% by weight, the anti-blocking property may be insufficient. When the content of the structural units derived from 1-butene is less than 3% by weight, the heat sealability may be insufficient or the anti-blocking property may be poor. When the content is over 10% by weight, the anti-blocking property may be insufficient.

The melting point of the propylene-based copolymerized component (1) of the present invention is within the range from 145 to 155° C., preferably within the range from 147 to 155° C., and more preferably within the range from 148 to 155° C. When the propylene-based copolymerized component (1), which is the major component, has a melting point lower than 145° C., the anti-blocking property may be poor. When the component has a melting point higher than 155° C., the temperature at which heat sealing can be achieved, which is hereinafter referred to as heat sealing temperature, may be too high.

The propylene-based copolymerized component (1) may contain structural units derived from α-olefins such as 1-pentene, 1-hexene, 1-octene and 3-methyl-1-butene.

The propylene-based copolymerized component (2) is a copolymerized component which comprises from 80 to 94% by weight of structural units derived from propylene, from 0 to 10% by weight of structural units derived from ethylene and from 0 to 20% by weight of structural units derived from 1-butene, and preferably comprises from 85 to 93% by weight of structural units derived from propylene, from 0.9 to 6% by weight of structural units derived from ethylene and from 6 to 15% by weight of structural units derived from 1-butene, where the amounts indicated above are based on the combined weight of all structural units of the component (2), namely the weight of the component (2).

When the content of the structural units derived from propylene is less than 80% by weight, the anti-blocking property may be insufficient. When the content is over 94% by weight, the heat sealing temperature may be high or the anti-blocking property may be poor. When the content of the structural units derived from ethylene is over 10% by weight, the anti-blocking property may be insufficient. When the content of structural units derived from 1-butene is over 20% by weight, the anti-blocking property may be insufficient.

The propylene-based copolymerized component (2) may contain structural units derived from α-olefins such as 1-pentene, 1-hexene, 1-octene and 3-methyl-1-butene. In the propylene-based copolymer material of the present invention, the composition of the propylene-based copolymerized component (1) is different from that of the propylene-based copolymerized component (2). Specifically, it is desirable that the content of the comonomer(s) of the propylene-based copolymerized component (1) be greater than the content of the comonomer(s) of the propylene-based copolymerized component (2). In other words, it is desirable that the content of the structural units derived from the monomer(s) other than propylene in the component (1) be greater than the content of the structural units derived from the monomer(s) other than propylene in the component (2).

The propylene-based copolymer material of the present invention contains from 1 to 10% by weight of the propylene-based copolymerized component (1) and from 90 to 99% by weight of the propylene-based copolymerized component (2), and preferably contains from 3 to 8% by weight of the propylene-based copolymerized component (1) and from 92 to 97% by weight of the propylene-based copolymerized component (2), where the amounts indicated above are based on the total weight of the propylene-based copolymerized components (1) and (2). When the content of the propylene-based copolymerized component (1) is less than 1% by weight, the anti-blocking property may be insufficient. When the content is over 10% by weight, the heat sealing temperature may be high.

The melting point of the propylene-based copolymer material of the present invention is not higher than 140° C., preferably not higher than 138° C., and more preferably not higher than 135° C. When the melting point of a propylene-based copolymer material is over 140° C., the heat sealability may be insufficient. In order for the propylene-based copolymer material of the present invention to satisfy such a requirement about melting point, it is desirable that the melting point of the propylene-based copolymerized component (2) be lower than the melting point of the propylene-based copolymerized component (1).

Polymerized components other than the propylene-based copolymerized components (1) and (2), such as polymers composed mainly of ethylene and polymers composed mainly of 1-butene, may be added to the propylene-based copolymer material of the present invention.

Examples of such polymers composed mainly of ethylene include ethylene homopolymers, ethylene-propylene copolymers produced by copolymerizing monomers containing ethylene, which is the major ingredient, and propylene, and copolymers produced by copolymerizing monomers containing ethylene and α-olefin having 4 or more carbon atoms, such as ethylene-1-butene copolymers, ethylene-1-hexene copolymers and ethylene-1-octene copolymers. The content of structural units derived from ethylene in such polymers is preferably 60% by weight or more.

Examples of polymers composed mainly of 1-butene include 1-butene homopolymers, 1-butene-ethylene copolymers or 1-butene-propylene copolymers obtained by copolymerizing 1-butene, which is the major component, and ethylene or propylene. Such polymers may be used singly or in combination. The content of structural units derived from 1-butene in such polymers is preferably 60% by weight or more.

The catalysts to be used in the preparation of the propylene-based copolymerized components (1) and (2) may be a Ziegler-Natta catalyst, a metallocene catalyst, or the like.

Examples of such a Ziegler Natta catalyst include Ti—Mg catalysts which comprise solid catalyst components produced by compounding a magnesium compound with a titanium compound, and catalysts produced by combining a solid catalyst component with an organoaluminum compound and, if necessary, a third component such as an electron-donating compound, the solid catalyst component having been prepared by compounding a magnesium compound with a titanium compound.

Preferable examples include catalysts comprising a solid catalyst component essentially containing magnesium, titanium and halogen, an organoaluminum compound and an electron-donating compound, disclosed in JP-A 61-218606, JP-A 61-287904, JP-A 7-216017, JP-A 2004-67850, etc.

The methods for the preparation of the propylene-based copolymerized components (1) and (2) may be a method in which given monomers are added together with a catalyst into an inert solvent, such as hexane, heptane, toluene and xylene, followed by their polymerization, a method in which comonomers such as ethylene and 1-butene are added together with a catalyst into liquid propylene, followed by polymerization of the monomers, a method in which a catalyst is added to propylene, ethylene, 1-butene or the like in a vapor phase and polymerization is performed in the vapor phase, or a combination of such methods.

The method for producing the propylene-based copolymer material of the present invention may be a method in which a propylene-based copolymerized component (1) and a propylene-based copolymerized component (2) are prepared as polymers separately and subsequently they are blended, a sequential polymerization method in which a propylene-based copolymerized component (1) is prepared in the first stage and subsequently, in the same polymerization reactor without deactivation of the catalyst, a propylene-based copolymerized component (2) is prepared in the second stage, a continuous polymerization method in which a propylene-based copolymerized component (1) is prepared in the first stage, followed by transfer to another polymerization reactor without deactivation of the catalyst, and then a propylene-based copolymerized component (2) is prepared in the second stage, or a combination of such methods.

The method for producing the propylene-based copolymer material of the present invention is preferably a method in which in the first stage in a medium composed mainly of liquid propylene a propylene-based copolymerized component is produced and then, in the second stage performed in another polymerization reactor to which the copolymerized component (1) has been transferred without deactivation of the catalyst, a propylene-based copolymerized component (2) is produced in a medium composed mainly of gaseous propylene. When this method is used, the energy required in the production is reduced to result in high productivity because copolymers hardly adhere together in the polymerization reactors and the yield per unit time increases.

The propylene-based copolymer material produced may be subjected to post-treatment, such as deactivation of a catalyst, removal of monomers, removal of solvents, drying, and pelletization. The deactivation of a catalyst is a process in which a product is brought into contact with a deactivating agent such as water. The removal of monomers is a process in which polymers and monomers are taken out from a polymerization reactor and the monomers are forced to leave by releasing the pressure. The removal of solvents is a process in which the solvent used in the polymerization is removed from polymers by proper means such as air flow, heating and pressure reduction. The pelletization is a process in which additives and polymers are mixed uniformly with a mixer such as a Henschel mixer, a Super mixer, a Nauta blender and a tumbler mixer and then the mixture is melt-kneaded and shaped into pellets using a single-screw extruder, a twin-screw extruder, a Banbury mixer, or the like. The drying is a process in which the solvent used in the polymerization and low-molecular substances in polymers are removed or reduced by proper means such as air flow, heating and pressure reduction.

To the propylene-based copolymer material of the present invention, various additives such as antioxidants, neutralizers, lubricants, anti-blocking agents, UV absorbers, antistatic agents, anticlouding agents, weathering agents, light stabilizers, nucleating agents, pigments, foaming agents, peroxides and fillers may be blended. The blending of such additives may be performed, for example, during pelletization.

The propylene-based copolymer material of the present invention can be used in various applications after being fabricated into shaped products by a proper method such as extrusion forming, injection molding, vacuum forming and expansion molding. The propylene-based copolymer material of the present invention is preferably fabricated into films by extrusion forming. The propylene-based copolymer material of the present invention can be fabricated into films by the T-die method or the tubular method. In a particularly preferred embodiment, it is fabricated into an unoriented film by the cast method using a T die.

A film containing the propylene-based copolymer material of the present invention may be either a monolayer film or a composite film having at least one layer made of a film containing the propylene-based copolymer material of the present invention. Since the propylene-based copolymer material of the present invention is excellent in heat sealability, it is preferably used for forming a surface layer of such a composite film. A film produced by vapor-depositing aluminum metal, silica, aluminum oxide or the like onto a film containing the propylene-based copolymer material of the present invention is also a preferred example of the film of the present invention.

Furthermore, a composite film produced by combining a film containing the propylene-based copolymer material of the present invention with a film(s) containing no propylene-based copolymer material of the present invention by lamination is also a preferred example of the film of the present invention. Examples of such a film containing no propylene-based copolymer material of the present invention include biaxially oriented polypropylene films, unoriented or oriented nylon films, oriented poly(ethyl terephthalate) films, aluminum foil and paper. Such composite films may be produced by heat lamination, dry lamination, extrusion lamination, or the like.

The thickness of a film containing the propylene-based copolymer material of the present invention is preferably within the range from 10 to 500 μm, and more preferably within the range from 10 to 100 μm. Films containing the propylene-based copolymer material of the present invention may be subjected to surface treatment, such as corona discharge treatment, flame treatment, plasma treatment and ozonization, by methods conventionally used in the industry.

Applications of films containing the propylene-based copolymer material of the present invention include packaging applications, for example, packaging of foods, fibers, sundries, etc.

### EXAMPLES

The invention is further described below with reference to Examples. The measurements in Examples and Comparative Examples were determined by the following methods.

### [1] The Amount of Coarse Particles

After separating a 200-gram portion of a resulting polymer powder through a sieve with a mesh aperture of 2 mm, the weight of the powder remaining on the sieve was measured and the amount of coarse particles (wt %) was calculated based on the measurement.

### [2] Content of Propylene-Based Copolymerized Component (1) or Propylene-Based Copolymerized Component (2) in Propylene-Based Copolymer Material

For products produced by continuous polymerization, the content of each component was calculated from the material balance in the polymerization. For products produced by mixing a propylene-based copolymerized component (1) and a propylene-based copolymerized component (2), it was calculated from the mixing ratio of the components.

[3] Content of Structural Units Derived from Ethylene in Propylene-Based Copolymerized Component (Hereinafter, Ethylene Content; in % by Weight)

The ethylene content was calculated in accordance with the method disclosed in “Kobunshi Handbook (Polymer Handbook)” page 616 (published by Kinokuniya Co., Ltd., 1995).

[4] Content of Structural Units Derived from 1-Butene in Propylene-Based Copolymerized Component (Hereinafter 1-Butene Content; in % by Weight)

The 1-butene content was calculated in accordance with the method disclosed in “Kobunshi Handbook (Polymer Handbook)” page 618 (published by Kinokuniya Co., Ltd., 1995).

[5] Content of Structural Units Derived from Propylene in Propylene-Based Copolymerized Component (Hereinafter, Propylene Content; in % by Weight)

The propylene content was calculated from the following formula.

(Propylene Content)=100−(Ethylene Content)−(1-Butene Content)

[6] Intrinsic Viscosity of a Polymer

Measurement was performed in 135° C. tetralin using an Ubbelohde viscometer.

[7] Density (in kg/m³) and Melt Flow Rate (Hereinafter, MFR; in g/10 Minutes) of an Ethylene Homopolymer.

The density was measured according to JIS K6760. The MFR was measured according to JIS K7210 at a temperature of 190° C. and a load of 2.16 kg.

[8] Melting point (Tm; in ° C.)

Using a differential scanning calorimeter (DSC produced by PerkinElmer, Inc.), about 10 mg of sample was melted at 220° C. in a nitrogen atmosphere, followed by rapid cooling to 150° C. After holding at 150° C. for 1 minute, the temperature was reduced to 50° C. at a rate of 5° C./min.

After holding at 50° C. for 1 minute, the temperature was increased at a rate of 5° C./minute. The peak temperature of the maximum peak in the fusion endothermic curve was rounded to the whole number, which was used as a Tm (melting point). When there were two or more peaks, the peak at the highest temperature was used.

It is noted that the Tm of indium (In) measured using that measuring instrument under the conditions described above was 156.6° C.

### [9] Heat Sealing Temperature (in ° C.)

After conditioning a film at 23° C. for 24 hours or more, heat sealing was performed in a region of 5 mm×10 mm at temperature intervals of 2° C. under a sealing pressure of 1 kgf/cm² using a heat gradient tester produced by Toyo Seiki Seisaku-sho Co., Ltd., where the temperatures were even integers. The resulting sealed portion was conditioned at 23° C. for 24 hours or more, followed by T-type peeling at a rate of 200 mm/min using a tensile tester. (The peeling direction is a direction such that the sealed portion will be peeled over a length of 10 mm and a width of 15 mm).

The heat sealing temperature which provided a seal strength of 300 gf was determined. A temperature between given temperatures was determined by interpolation in a linear equation.

[10] Anti-Blocking Property (in kgf/12 cm²)

Two pieces of film each having a size of 150 mm×30 mm were prepared so that the machine direction (MD) in the film production might match the longitudinal direction of each piece. They were layered together in a manner that the surfaces which had been in contact with a chill roll met together and were conditioned at 80° C. for 3 hours under a load of 500 g in an area of 40 mm×30 mm. Then, the sample was left at rest for at least 30 minutes in an atmosphere having a temperature of 23° C. and a humidity of 50%. Thereafter, the films were peeled at a rate of 200 mm/min using a tensile tester produced by Toyo Seiki Seisaku-sho Co., Ltd. The force needed for the peeling of the films was measured.

### Example 1

### Preparation and Preactivation of Solid Catalyst

To 15 g of a solid catalyst component containing magnesium, titanium and halogen which was produced according to Example 1 of JP-A 2004-67850, 1.5 liters of n-hexane fully dehydrated and degassed, 37.5 mmol of triethylaluminum and 3.75 mmol of cyclohexylethyl dimethoxysilane were added. Then, while keeping the temperature in the reactor within the range from 5 to 15° C., preactivation was performed by continuously feeding 15 g of propylene.

### (Production of Propylene-Based Copolymer Material)

Polymerization was performed using two polymerization reactors connected in series.

In a 20-liter polymerization reactor made of SUS as a first reactor, continuous polymerization was performed by continuously feeding 45 mmol/h of triethylaluminum, 12 mmol/h of cyclohexylmethyldimethoxysilane and 0.86 g/h of the preactivated solid catalyst component while supplying 50 kg/h of liquid propylene, 7 kg/h of 1-butene and 60 liters/h of hydrogen so as to maintain a polymerization temperature of 55° C. and a polymerization pressure of 3.2 MPa. The rate of polymer generation in this reactor was 1.2 kg/h. A part of the polymer was sampled as a propylene-based copolymerized component (1) and was analyzed. As a result, it was found to have an intrinsic viscosity of 1.7 dl/g, a 1-butene content of 4.6% by weight, a propylene content of 95.4% by weight, and a melting point of 154° C. The whole portion of the polymer produced was transferred continuously to a second polymerization reactor without deactivating the catalyst.

Using a 1-m³ fluidized bed reactor equipped with a stirrer as the second reactor, propylene polymerization in the catalyst-containing polymer transferred from the first reactor was continued while supplying propylene, ethylene, 1-butene and hydrogen so as to maintain a polymerization temperature of 80° C., a polymerization pressure of 1.8 MPa, an ethylene concentration in the vapor phase of 1.2 vol %, a 1-butene concentration in the vapor phase of 12 vol % and a hydrogen concentration in the vapor phase of 1.4 vol %. At the outlet of the second reactor, a polymer was obtained at a rate of 23.1 kg/h. The polymer had an intrinsic viscosity of 1.7 dl/g, an ethylene content of 1.7% by weight, and a 1-butene content of 9.5% by weight. The melting point of the polymer was 134° C. The polymer contained 0.2% by weight of coarse particles as large as 2 mm or more; it had good particle properties.

Based on the results shown above, the rate of generation of a propylene-based copolymerized component (2) in the second reactor was 21.9 kg/h. The weight ratio of the propylene-based copolymerized component (1) to the propylene-based copolymerized component (2) is 5.2:94.8. The ethylene content, the butene content and the propylene content of the propylene-based copolymerized component (2) were calculated to be 1.8% by weight, 9.8% by weight, and 88.4% by weight, respectively.

### (Production of Film)

To 99.5 parts by weight of the propylene-based copolymer material produced by the polymerization, 3.5 parts by weight of an ethylene homopolymer (commercial name: G1900, produced by Keiyo Polyethylene Co., Ltd.) having a density of 960 kg/m³ and an MFR of 16 g/10 minutes, 0.10 parts by weight of pentaerythrityl tetrakis[3-(3,5-di-tert-butyl-4-hydroxyphenyl)propionate] (commercial name: IRGANOX1010), 0.15 parts by weight of a phosphorus-based antioxidant, tris(2,4-di-tert-butylphenyl)phosphite (commercial name: IRGAFOS168), and 0.35 parts by weight of synthetic zeolite (commercial name: SILTON JC-40, produced by Mizusawa Industrial Chemicals, Ltd.) having an average particle diameter of 4 μm (determined by the Coulter method) were added. The mixture was mixed uniformly at 535 rpm using a 20-liter SUPER MIXER (produced by KAWATA MFG Co., Ltd.) and then was pelletized at 230° C. using a 40-mm single-screw extruder (Model VS40-28, produced by Tanabe Plastics Machinery Co., Ltd., having a full flight screw).

The resulting pellets were subjected to melt extrusion at a resin temperature of 240° C. using a 50-mm T-die film extruder (Film extruder V-50-F600, produced by Tanabe Plastics Machinery Co., Ltd., having a 400 mm wide T-die). The melt extrudate was cooled on a chill roll in which 40° C. cooling water was circulated, thereby yielding a film 40 μm in thickness.

### Examples 2 to 4

Propylene-based copolymer materials each containing a propylene-based copolymerized component (1) and a propylene-based copolymerized component (2) in a composition given in Table 1 were produced by changing the amounts of propylene, ethylene, 1-butene and hydrogen in the first reactor and the second reactor in the production of the propylene-based copolymer material in Example 1. All the polymer materials contained not more than 1% by weight of coarse particles; they had good particle properties. From the polymer materials obtained, films were produced in the same manner as Example 1.

### Referential Example

### Preparation and Preactivation of Solid Catalyst

To 15 g of a solid catalyst component containing magnesium, titanium and halogen which was produced according to Example 1 of JP-A 2004-67850, 1.5 liters of n-hexane fully dehydrated and degassed, 37.5 mmol of triethylaluminum and 1.88 mmol of cyclohexylethyl dimethoxysilane were added. Then, while keeping the temperature in the reactor within the range from 5 to 15° C., preactivation was performed by continuously feeding 37.5 g of propylene.

### (Production of Propylene-Based Copolymer)

Using a 1-m³ fluidized bed reactor equipped with a stirrer, polymerization was performed by continuously feeding 42 mmol/h of triethylaluminum, 11 mmol/h of cyclohexylmethyldimethoxysilane and 0.78 g/h of the preactivated solid catalyst component while supplying propylene, ethylene, 1-butene and hydrogen so as to maintain a polymerization temperature of 80° C., a polymerization pressure of 1.8 MPa, an ethylene concentration in the vapor phase of 1.3 vol %, a 1-butene concentration in the vapor phase of 12 vol % and a hydrogen concentration in the vapor phase of 1.4 vol %. At the outlet of the reactor, a polymer was obtained at a rate of 23.8 kg/h. The polymer had an intrinsic viscosity of 1.7 dl/g, an ethylene content of 1.9% by weight, and a 1-butene content of 9.0% by weight. The melting point of the polymer was 132° C. The polymer contained many, namely, 17% by weight of coarse particles as large as 2 mm or more.

### Comparative Examples 1 and 2

Propylene-based copolymer materials each containing a propylene-based copolymerized component (1) and a propylene-based copolymerized component (2) in the composition given in Table 1 were produced by changing the amounts of propylene, ethylene, 1-butene and hydrogen in the first reactor and the second reactor in the production of the propylene-based copolymer material in Example 1. Both the polymer materials contained not more than 1% by weight of coarse particles as large as 2 mm or more; they had good particle properties. From the polymer materials obtained, films were produced in the same manner as Example 1.

### Comparative Example 3

A propylene-based copolymer material containing a propylene-based copolymerized component (1) and a propylene-based copolymerized component (2) in the composition given in Table 1 was produced by changing the amounts of propylene, ethylene, 1-butene and hydrogen in the first reactor and the second reactor in the production of the propylene-based copolymer material in Example 1. The polymer contained 0.1% by weight of coarse particles as large as 2 mm or more; it had good particle properties.

A film was produced in the same manner as Example 1 except for adding 1.5 parts by weight of an ethylene homopolymer, 0.10 parts by weight of pentaerythrityl tetrakis[3-(3,5-di-tert-butyl-4-hydroxyphenyl)propionate] (commercial name: IRGANOX1010), 0.15 parts by weight of a phosphorus-based antioxidant, tris(2,4-di-tert-butylphenyl)phosphite (commercial name: IRGAFOS168), and 0.25 parts by weight of synthetic zeolite (commercial name: SILTON JC-40, produced by Mizusawa Industrial Chemicals, Ltd.) having an average particle diameter of 4 μm (determined by the Coulter method) to 98.5 parts by weight of the propylene-based copolymer material produced by the polymerization.

### Example 5

As a propylene-based copolymerized component (1) and a propylene-based copolymerized component (2), 7.3 parts by weight of a polymer having a propylene content of 95.4% by weight, an ethylene content of 1.0% by weight, a 1-butene content of 3.6% by weight, a melting point of 148° C. and an intrinsic viscosity of 1.6 dl/g produced by use of the same catalyst as Example 1 and 92.7 parts by weight of the propylene-based copolymer of Referential Example were used, respectively. To 99.5 parts by weight of a uniform blend composed of the two propylene-based copolymer materials, 3.5 parts by weight of an ethylene homopolymer (commercial name: G1900, produced by Keiyo Polyethylene Co., Ltd.) having a density of 960 kg/m³ and an MFR of 16 g/10 minutes, 0.10 parts by weight of pentaerythrityl tetrakis[3-(3,5-di-tert-butyl-4-hydroxyphenyl)propionate] (commercial name: IRGANOX1010), 0.15 parts by weight of a phosphorus-based antioxidant, tris(2,4-di-tert-butylphenyl)phosphite (commercial name: IRGAFOS168), and 0.35 parts by weight of synthetic zeolite (commercial name: SILTON JC-40, produced by Mizusawa Industrial Chemicals, Ltd.) having an average particle diameter of 4 μm (determined by the Coulter method) were added. The mixture was mixed uniformly at 535 rpm using a 20-liter SUPER MIXER (produced by KAWATA MFG Co., Ltd.) and then was pelletized at 230° C. using a 40-mm single-screw extruder (Model VS40-28, produced by Tanabe Plastics Machinery Co., Ltd., having a full flight screw).

The resulting pellets were subjected to melt extrusion at a resin temperature of 240° C. using a 50-mm T-die film extruder (Film extruder V-50-F600, produced by Tanabe Plastics Machinery Co., Ltd., having a 400 mm wide T-die). The melt extrudate was cooled on a chill roll in which 40° C. cooling water was circulated, thereby yielding a film 40 μm in thickness.

### Comparative Example 4

Operations were performed in the same manner as Example 5 except for using 12.5 parts by weight of a polymer having a propylene content of 98.5% by weight, an ethylene content of 1.5% by weight and a melting point of 154° C. produced by use of the same catalyst as Example 1 and 87.5 parts by weight of the propylene-based copolymer of Comparative Example 1 as a propylene-based copolymerized component (1) and a propylene-based copolymerized component (2), respectively.

### Comparative Example 5

Operations were performed in the same manner as Example 5 except for using, as a propylene-based copolymerized component (1), a polymer having a propylene content of 75% by weight, a 1-butene content of 25% by weight, a melting point of 130° C. and an intrinsic viscosity of 2.1 dl/g produced by use of the same catalyst as Example 1.

### Comparative Example 6

Operations were performed in the same manner as Example 5 except for using, as a propylene-based copolymerized component (2), a polymer having a propylene content of 95.4% by weight, an ethylene content of 4.6% by weight, a melting point of 139° C. and an intrinsic viscosity of 1.6 dl/g produced by use of the same catalyst as Example 1.

Properties of the propylene-based copolymer materials and properties of the films of the Examples, the Comparative Examples and the Reference Example are summarized in Tables 1 and 2.

TABLE 1

| | Examples | | | | | Ref. |
|---|---|---|---|---|---|---|
| | 1 | 2 | 3 | 4 | 5 | Example |
| Copolymerized | | | | | | |
| component (1) | | | | | | |
| Propylene content (wt %) | 95.4 | 95.6 | 96.7 | 95.0 | 95.4 | — |
| Ethylene content (wt %) | 0 | 1.4 | 0 | 0 | 1.0 | — |
| 1-Butene content (wt %) | 4.6 | 3.0 | 3.3 | 5.0 | 3.6 | — |
| Melting point (° C.) | 154 | 148 | 155 | 154 | 148 | — |
| Copolymerized | | | | | | |
| component (2) | | | | | | |
| Propylene content (wt %) | 88.4 | 90.6 | 90.2 | 87.4 | 89.1 | 89.1 |
| Ethylene content (wt %) | 1.8 | 2.5 | 2.7 | 1.9 | 1.9 | 1.9 |
| 1-Butene content (wt %) | 9.8 | 6.9 | 7.1 | 10.7 | 9.0 | 9.0 |
| Copolymer material | | | | | | |
| Content of | 5.2 | 7.3 | 4.7 | 5.0 | 7.3 | 0 |
| component (1) (wt %) | | | | | | |
| Content of | 94.8 | 92.7 | 95.3 | 95.0 | 92.7 | 100 |
| component (2) (wt %) | | | | | | |
| Melting point (° C.) | 134 | 133 | 133 | 132 | 134 | 132 |

| | Comparative Examples | | | | | |
|---|---|---|---|---|---|---|
| | 1 | 2 | 3 | 4 | 5 | 6 |
| Copolymerized | | | | | | |
| component (1) | | | | | | |
| Propylene content (wt %) | 98.3 | 99.06 | 95.4 | 98.5 | 75 | 95.4 |
| Ethylene content (wt %) | 1.7 | 0.94 | 0 | 1.5 | 0 | 1.0 |
| 1-Butene content (wt %) | 0 | 0 | 4.6 | 0 | 25 | 3.6 |
| Melting point (° C.) | 155 | 158 | 154 | 154 | 130 | 148 |
| Copolymerized | | | | | | |
| component (2) | | | | | | |
| Propylene content (wt %) | 88.7 | 89.0 | 89.7 | 89.1 | 89.1 | 95.4 |
| Ethylene content (wt %) | 2.2 | 1.9 | 0.9 | 1.9 | 1.9 | 4.6 |
| 1-Butene content (wt %) | 9.1 | 9.1 | 9.4 | 9.0 | 9.0 | 0 |
| Copolymer material | | | | | | |
| Content of | 7.3 | 6.5 | 6.1 | 12.5 | 7.3 | 5.0 |
| component (1) (wt %) | | | | | | |
| Content of | 92.7 | 93.5 | 93.9 | 87.5 | 92.7 | 95.0 |
| component (2) (wt %) | | | | | | |
| Melting point (° C.) | 134 | 138 | 141 | 137 | 132 | 139 |

TABLE 2

| | Heat sealing | Blocking |
|---|---|---|
| | temperature (° C.) | (kg/12 cm²) |
| Example 1 | 134 | 0.55 |
| Example 2 | 132 | 0.53 |
| Example 3 | 133 | 0.52 |
| Example 4 | 131 | 0.47 |
| Example 5 | 134 | 0.68 |
| Comparative Example 1 | 132 | 0.73 |
| Comparative Example 2 | 136 | 0.71 |
| Comparative Example 3 | 142 | 0.33 |
| Comparative Example 4 | 135 | — |
| Comparative Example 5 | 131 | 0.87 |
| Comparative Example 6 | 140 | 1.48 |

It is shown that the films of Examples 1 to 5 are excellent in heat sealability and anti-blocking property; however, the films of Comparative Examples 1 to 6 are poor in either heat sealability or antiblocking property or both. The copolymer of Referential Example, which contains only a propylene-based copolymerized component (2) without containing a propylene-based copolymerized component (1), includes many coarse particles.

What is claimed is:

1. A propylene-based copolymer material which comprises from 1 to 10% by weight of a propylene-based copolymerized component (1) defined below and from 90 to 99% by weight of a propylene-based copolymerized component (2) defined below and which has a melting point not higher than 140° C., where the amounts are based on the total weight of the propylene-based copolymerized components (1) and (2), wherein the propylene-based copolymerized component (1) is a propylene-based copolymerized component which comprises from 89 to 97% by weight of structural units derived from propylene, from 0 to 1.5% by weight of structural units derived from ethylene and from 3 to 10% by weight of structural units derived from 1-butene and which has a melting point within the range from 145° C. to 155° C., where the amounts are based on the weight of the component (1), and
the propylene-based copolymerized component (2) is a propylene-based copolymerized component which comprises from 80 to 94% by weight of structural units derived from propylene, from 0 to 10% by weight of structural units derived from ethylene and from 0 to 20% by weight of structural units derived from 1-butene, where the amounts are based on the weight of the component (2).

2. The propylene-based copolymer material according to claim 1, wherein the content of the structural units derived from ethylene of the propylene-based copolymerized component (1) is 0% by weight.

3. A film comprising the propylene-based copolymer material according to claim 1.

4. The film according to claim 3, wherein the film is an unoriented film.

5. A method for producing the propylene-based copolymer material according to claim 1, wherein the propylene-based copolymerized component (1) is produced in a medium composed mainly of liquid propylene and the propylene-based copolymerized component (2) is produced in a medium composed mainly of gaseous propylene.

6. The method according to claim 5, wherein the content of ethylene contained in the medium composed mainly of liquid propylene used for the production of the propylene-based copolymerized component (1) is 0% by weight.
